(19) United States
(12) Patent Application Publication
(10) Pub. No.: US 2008/0178645 A1
(43) Pub. Date: Jul. 31, 2008

(54) SHIFT LOCK MECHANISM USING NICKEL TITANIUM

(76) Inventors: Brian Douglas Howe, Shelby Twp., MI (US); Stephen Gerard Wieczerza, White Lake, MI (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/617,292

(22) Filed: Dec. 28, 2006

(51) Int. Cl. G05G 5/00; E05B 65/12

(52) U.S. Cl. 70/201; 70/247

(57) ABSTRACT

A locking mechanism for a shift lever includes a detent member movable along a predetermined path, a stopper member movable between a locking position wherein the stopper member is within the path of the detent member to block movement of the detent member along at least a portion of the path and an unlocking position wherein stopper member is positioned to permit the detent member to move along the path, and a control member comprising a shape memory alloy. The control member selectively applies a force to the stopper member to move the stopper member toward the unlocking position in response to heat being applied to the shape memory alloy.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to shifter assemblies for controlling transmissions of motor vehicles and, more particularly, to a locking mechanism for locking a shift lever in a predetermined gear position against movement to other gear positions when predetermined conditions are present.

### BACKGROUND OF THE INVENTION

In a vehicle equipped with an automatic transmission, a shift lever is typically pivotable over a series of positions representative of transmission gears such as, for example, park (P), reverse (R), neutral (N), drive (D), and low gears (2, 1). The shift lever is operably connected to the motor vehicle transmission by a suitable mechanical and/or electronic operating linkage to effect actuation of the transmission to the selected gear when the shift lever is pivoted to the transmission gear's representative position. The shift lever is typically provided with a knob assembly having a detent member which releasably holds the shift lever in its current position to prevent inadvertent movement of the shift lever. The knob assembly typically includes a manually operable button which permits the operator to release the detent member and move the shift lever.

The shift lever can be provided with a locking mechanism which locks the shift lever in a predetermined gear position against movement to other gear positions when predetermined conditions are present. The lock mechanism thus disables the knob assembly so that the operator cannot move the shift lever under certain predetermined conditions. Typically, the lock mechanism prevents movement of the shift lever out of the park position unless a brake foot pedal is depressed and/or other desired conditions are present to reduce the likelihood of unattended or unintended movement or acceleration of the vehicle. These locking mechanisms typically have mechanically or electrically actuated devices which block movement of the detent member unless the predetermined conditions are met. These locking mechanisms, however, often generate undesirable levels of noise as they are activated and/or deactivated.

U.S. Pat. No. 5,671,638, the disclosure of which is expressly incorporated herein in its entirety by reference, discloses a locking mechanism for a shift lever.

U.S. Pat. No. 5,799,517, the disclosure of which is expressly incorporated herein in its entirety by reference, discloses another locking mechanism for a shift lever.

U.S. Pat. No. 6,852,065, the disclosure of which is expressly incorporated herein in its entirety by reference, discloses another locking mechanism for a shift lever.

There is a desire to reduce the noise level of locking mechanisms for shift levers. Also, there is a never ending desire in the motor vehicle industry to reduce size, weight, and cost while retaining and/or obtaining desirable characteristics. Accordingly, there is a need in the art for an improved locking mechanism for a shift lever.

### SUMMARY OF THE INVENTION

The present invention provides a locking mechanism for a shift lever which addresses one or more problems of the related art. According to the present invention, a locking mechanism for a shift lever comprises, in combination, a stopper member movable between a locking position wherein the stopper member is within the path of the detent member to block movement of the detent member along at least a portion of the path and an unlocking position wherein stopper member is positioned to permit the detent member to move along the path, and a control member comprising a shape memory alloy. The control member selectively applies a force to the stopper member to move the stopper member toward the unlocking position in response to heat being applied to the shape memory alloy.

According to another aspect of the present invention, a locking mechanism for a shift lever comprises, in combination, a detent member movable along a predetermined path, a stopper member movable between a locking position wherein the stopper member is within the path of the detent member to block movement of the detent member along at least a portion of the path and an unlocking position wherein stopper member is positioned to permit the detent member to move along the path, a control member comprising Nickel-Titanium, and a spring member resiliently biasing the stopper member toward the locking position. The control member selectively applies a force to the stopper member to move the stopper member toward the unlocking position in response to heat being applied to the Nickel-Titanium.

According to yet another aspect of the present invention, a locking mechanism for a shift lever comprises, in combination, a detent member movable along a predetermined path, a stopper member movable between a locking position wherein the stopper member is within the path of the detent member to block movement of the detent member along at least a portion of the path and an unlocking position wherein stopper member is positioned to permit the detent member to move along the path, a control member comprising a Nickel-Titanium wire, and a spring member resiliently biasing the stopper member toward the locking position. The control member selectively applies a force to the stopper member to move the stopper member toward the unlocking position in response to heat being applied to the Nickel-Titanium wire. An effective length of the control member decreases when the Nickel-Titanium wire is heated to pull the stopper member toward the unlocking position.

From the foregoing disclosure and the following more detailed description of various preferred embodiments it will be apparent to those skilled in the art that the present invention provides a significant advance in the technology and art of motor vehicle shift lever locking mechanisms. Particularly significant in this regard is the potential the invention affords for providing a high quality, reliable, low cost assembly which is relatively quiet. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of a shifter assembly having a locking mechanism according to the present invention;

FIG. 2 is an enlarged, fragmented side elevational view, partially in cross-section, showing the locking mechanism of the shifter assembly of FIG. 1 according to a first embodiment of the invention, wherein the locking mechanism is in its locking position;

FIG. 3 is a side elevational view of the locking mechanism of FIG. 2, wherein a shift lever knob assembly is actuated while the locking mechanism is in its unlocking position;

FIG. 4 is an electrical schematic of the locking mechanism of FIGS. 1 to 3;

FIG. 5 is an enlarged, fragmented elevational schematic view, partially in cross-section, showing the locking mechanism of the shifter assembly of FIG. 1 according to a second embodiment of the invention, wherein the locking mechanism is in its locking position; and

FIG. 6 is an elevational view of the locking mechanism of FIG. 5, but wherein the shift lever knob assembly is actuated while the locking mechanism is in its unlocking position.

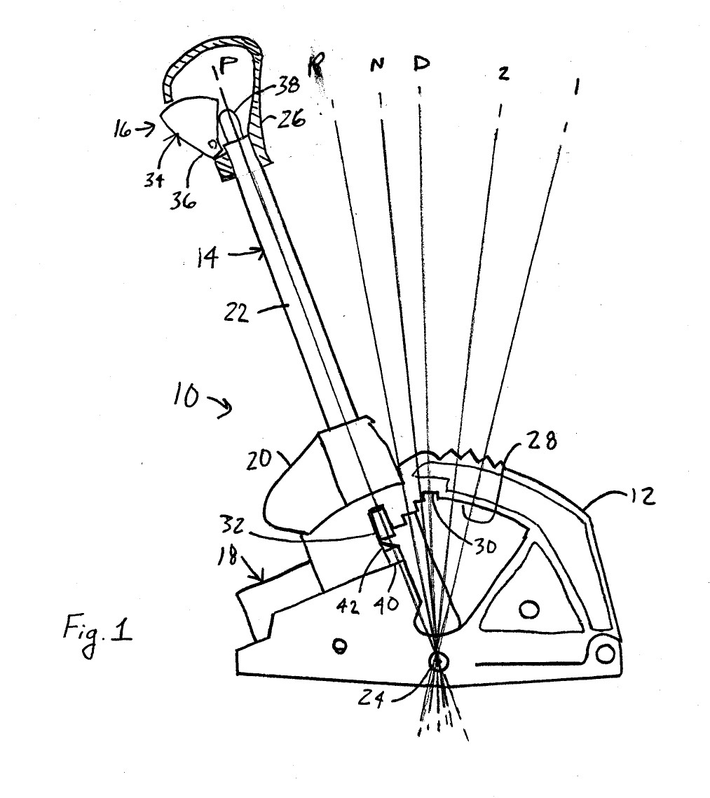

It should be understood that the appended drawings are not necessarily to scale, presenting a somewhat simplified representation of various preferred features illustrative of the basic principles of the invention. The specific design features of a locking mechanism for a shift lever as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the shifter assembly illustrated in the drawings. In general, up or upward generally refers to an upward direction within the plane of the paper in FIG. 1 and down or downward generally refers to a downward direction within the plane of the paper in FIG. 1. Also in general, fore or forward refers to a direction toward the front of the vehicle, that is, generally toward the left within the plane of the paper in FIG. 1 and aft or rearward refers to a direction toward the rear of the vehicle, that is, generally toward the right within the plane of the paper in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved locking mechanism for a shift lever disclosed herein. The following detailed discussion of various alternative and preferred embodiments will illustrate the general principles of the invention with reference to a shift lever locking mechanism for a motor vehicle such as an automobile, truck, van, cross over vehicle, sport utility vehicle (SUV), recreational vehicle, trailer, off road vehicle such as a dune buggy, industrial or construction equipment, golf cart, or the like. Other embodiments suitable for other applications of the invention will be apparent to those skilled in the art given the benefit of this disclosure.

Referring now to the drawings, FIG. 1 shows a shifter assembly 10 according to a preferred embodiment of the present invention. The illustrated shifter assembly 10 includes a frame or base 12, a shift lever assembly 14 movable relative to the base 12 over a shift path defining a plurality of gear positions, a knob assembly 16 releasably holding the shift lever assembly 14 in a desired one of a plurality of gear positions against undesired and/or inadvertent movement to the other gear positions, and a locking mechanism 18 for locking the shift lever assembly 14 in a predetermined one of the gear positions against movement to the other gear positions when predetermined conditions are present.

The illustrated base 12 is adapted to be attached to the motor vehicle in a fixed position such as a floor or console. The base 12 is shaped to engage the motor vehicle in a desired manner and is typically provided with openings or holes for receiving mechanical fasteners such as bolts to secure the base to the motor vehicle.

The illustrated shift lever assembly 14 includes a pivot member 20, a shift lever or post 22 for manually moving the pivot member 20. The lower end of the pivot member 20 is sized and shaped to extend between pivot flanges of the base 12 and cooperate with the base 12 to provide a pivotable connection between the pivot member and the base 12. Pivotably connected in this manner, the pivot member 20 is pivotable about a horizontal and laterally extending pivot axis 24 so that shift lever assembly 14 moves over a generally straight shift path extending in the forward-rearward direction. It is noted, however, that the shift path can alternatively have any other suitable shape and/or direction such as, for example, the shift path could alternatively include laterally extending portions.

The illustrated shift lever 22 is generally an elongate tube having a hollow central passage. The lower end of the shift lever 22 is adapted to be secured to the pivot member 20. With the shift lever 22 secured to the pivot member 20, the pivot member 20 can be pivoted about the pivot axis 24 by manually applying a force to the shift lever 22. The upper end of the illustrated shift lever 22 is provided with handle or knob 26. The knob 26 is preferably provided with a shape to provide a suitable gripping surface for the hand of the operator.

The illustrated base 12 has a detent plate or gate 28 having a curvature about the pivot axis 24. The illustrated gate 28 has a lower contoured surface with a plurality of downward facing grooves or notches 30 formed therein. The notches 30 define the various gear positions along the shift path which the shift lever assembly 14 can be moved to provide a desired gear at the transmission of the motor vehicle. The illustrated notches 30 define the gear positions of park (P), reverse (R), neutral (N), drive (D), second low gear (2), and first low gear (1). It is noted, however, that the notches 30 can alternatively define any other suitable plurality of gear positions. The shift lever assembly 14 is operably connected to the transmission of the motor vehicle via mechanical and/or electrical linkages such that movement the shift lever assembly 14 to the various gear positions along the shift path causes the transmission to move to the corresponding gear. The notches 30 are sized and shaped to cooperate with the knob assembly 16 to limit movement of the shift lever assembly 14 as discussed in more detail hereinbelow. The illustrated notches 30 are each rectangular shaped and are sized differently in order to control movement of the shift lever assembly 14 in a desired manner. It is noted that the notches 30 can alternatively have other suitable shapes such as, for example, arcuate and/or can each be sized the same.

The illustrated knob assembly 16 includes the knob 26, a detent member or gate pin 32 movable into and out of engagement with the notches 30, and an actuator 34 for selectively moving the detent member 32. The illustrated knob assembly 16 is secured to the shift lever assembly 14 for movement therewith but alternatively the gate 28 and the gate pin 32 can be reversed. The pivot member 20 forms a guide opening or passage for the detent member 32 so that the detent member 32 is linearly moved by the actuator 34 along a linear path extending toward and away from the notches 30, that is, in a direction substantially perpendicular to the notches 30. The illustrated detent member 32 moves along the central axis of the shift lever assembly 14 and intersects the pivot axis 24. The detent member 32 is sized and shaped to closely cooperate with the guide opening so that the guide opening guides the detent member 32 to maintain movement of the detent member 32 along the linear path. The detent member 32 is also sized and shaped to cooperate with the notches 30 of the gate 28 so that the detent member 32 blocks and limits pivotal movement of the shift lever assembly 14 when the detent member 32 is in one of the notches 30 but permits pivotal movement of the shift lever assembly 14 when the detent member 32 is removed from the notch 30. The engagement portion of the illustrated detent member 32 is generally rectangular to cooperate with the rectangular-shaped notches 30 but any other suitable shape can alternatively be utilized.

The illustrated actuator 34 includes a manually operated button member 36 and a connecting member or rod 38 extending from the button member 36 to the detent member 32. The illustrated button member 36 is pivotably secured to the knob 26 and is provided with an engagement surface sized and shaped for interacting with the connecting rod 38. The illustrated connecting rod 38 extends within the interior passage of the shift lever 22 and is linearly movable along the central axis of the shift lever 22. The lower end of the connecting rod 38 is secured to the detent member 32. The upper end of the connecting rod 38 is sized and shaped to interact with the button member 36 so that manual actuation of the button member 36 in a direction into the knob 26 linearly and downwardly moves the connecting rod 38 and the detent member 32 connected thereto toward the pivot axis 24 and away from the notches 30. A spring member is preferably provided within the shift lever 22 to resiliently bias the connecting rod 38 in an upward direction so that the detent member 32 is resiliently biased toward the notches 30. It is noted that the actuator 34 can alternatively be of any other suitable type such as, for example, an electric linear actuator with a control switch.

The illustrated locking mechanism 18 is positioned at a forward end of the base 12 adjacent the notch 30 defining the park gear position so that the locking mechanism 18 prevents movement of the shift lever assembly 14 out of the park gear position unless a foot brake pedal is depressed and an ignition key is present or activated to reduce the likelihood of unattended or unintended movement or acceleration of the motor vehicle. It is noted that the locking mechanism 18 can alternatively be utilized to secure the shift lever assembly 14 in any other gear position. It is also noted that the locking mechanism 18 can be operated upon the presence of any other suitable predetermined conditions.

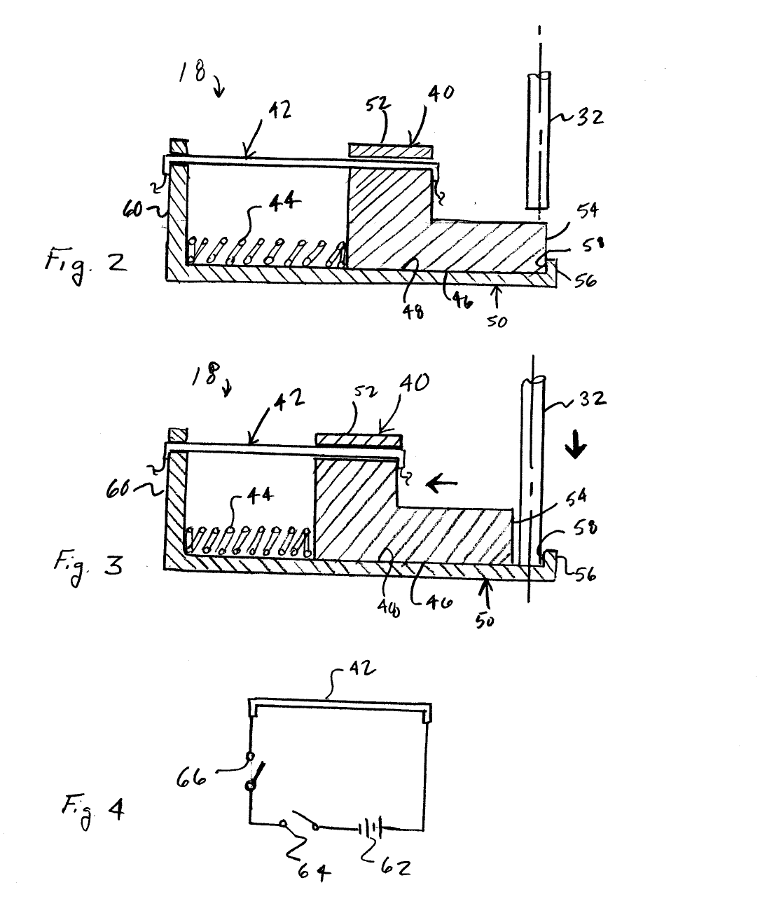

As best shown in FIGS. 2 to 4, the illustrated locking mechanism 18 includes a stopper member 40 movable between a locking position wherein the stopper member 40 is within the path of the detent member 32 to block movement of the detent member along at least a portion of the path and prevent removal of the detent member 32 from the notch 30 and an unlocking position wherein stopper member 40 is positioned to permit the detent member 32 to move along the path out of the notch 30. The illustrated locking member also includes a control member 42 selectively applying a force to the stopper member 40 to move the stopper member 40 toward its unlocking position when activated and a spring member resiliently biasing the stopper member toward its locking position.

The illustrated stopper or blocker member 40 is movable along a horizontal linear path between a locking or blocking position wherein the stopper member 40 is within a portion of the linear path of the detent member 32 to block movement of the detent member out of the notch 30 defining the park gear position (best shown in FIG. 2) and an unlocking or unblocking position wherein stopper member 40 is positioned so that it does not block the linear path of the detent member 32 to permit the detent member 32 to move along the linear path out of the notch 30 defining the park gear position (best shown in FIG. 3). The illustrated stopper member 40 is generally rectangular shaped having a substantially planar lower surface 46 but any other suitable shape can be utilized. The lower surface 46 engages a planar upper surface 48 of a fixed mounting bracket or base 50 upon which the stopper member 40 slides between its locking and unlocking positions. The mounting bracket 50 is secured to the base 12 of the shifter assembly 10. The illustrated stopper member 40 has a rear or blocking end portion sized and shaped to block movement of the detent member 32. The illustrated stopper member 40 also has a vertically extending flange 52 near the rear end of the stopper member 40 and forward of the blocking end portion. The flange 52 is sized and shaped to support the control member 42 as described in more detail hereinafter.

The illustrated spring member 44 extends between the mounting bracket 50 and a forward end of the stopper member 40 to resiliently bias or urge the stopper member 40 in a rearward direction toward its locking position where a rearward facing abutment 54 of the stopper member 40 engages a stop 56 having a forward facing abutment 58. The illustrated spring member 44 is a compression spring that engages a rearward facing side of a forward wall or flange 60 of the mounting bracket 50 and a forward end of the stopper member 40, that is, the end of the stopper member 40 opposite the detent member 32. The illustrated spring member 44 is a helical coil compression spring but any other suitable type of resilient spring member can alternatively be utilized.

The illustrated control member 42 comprises a shape memory alloy or memory metal to selectively apply a force to the stopper member 40 to move the stopper member 40 toward its unlocking position when heat is applied to shape memory alloy as described in more detail hereinafter. A shape memory alloy has the property of remembering its shape so that a change in temperature converts its shape to a preprogrammed structure. The shape memory alloy can be any suitable shape memory alloy such as, for example, Nickel-Titanium (Ni—Ti). While Ni—Ti is relatively soft and easily deformable in its low temperature form (martensite), it resumes its original shape and rigidity when heated to its higher temperature form (austenite) The illustrated control member 42 is a Ni—Ti wire extending between the flange 60 of the mounting bracket 50 and the flange 52 of the but any other suitable shape can be utilized. The illustrated control member 42 is configured so that its effective length is decreased when the control member 42 is heated to move the stopper member 40 in a forward direction from its locking position toward its unlocking position.

The illustrated control member 42 is heated by passing an electric current through the control member 42 but it is noted that the control member 42 can alternatively be heated in any other suitable manner. The illustrated control member 42 has ends electrically connected to an electric power source 62 such as, for example, the vehicle battery through first and second switches 64, 66 which are closed when the vehicle brake pedal is depressed and the key is in the ignition respectively. It is noted that any other suitable control circuit can be utilized within the scope of the present invention.

As best shown in FIG. 2, the spring member 44 biases the stopper member 40 to its locking position within the path of the detent member 32 and against the stop 56 when the shift lever assembly 14 is in the park position P. If the predetermined conditions are not met (for example, the foot brake pedal is not depressed and the key is not in or operating the ignition), the control member 42 is unactivated, that is, unheated. If the operator actuates the knob assembly 16 to move the shift lever assembly 14 while the control member 42 is unactivated, the detent member 32 engages the stopper member 40. The engagement with the stopper member 40 prevents further downward movement of the detent member 32 along its linear path so that the detent member 32 cannot be removed from the park gear notch 30. Thus, the operator cannot remove the shift lever assembly 14 from the park gear position. If the predetermined conditions are met (for example, the foot brake pedal is depressed and the key is in or operating the ignition), the switches 64 and 66 are closed so that electric current flows through the control member 42 to heat the control member 42. When the control member 42 is activated, that is heated, the effective length of the control member 42 is reduced to pull the stopper member 40 in a forward direction toward its unlocking position against the bias of the spring member 44. As best shown in FIG. 3, if the operator actuates the knob assembly 16 to move the shift lever assembly 14 while the control member 42 is activated, the stopper member 40 is out of its path and the detent member 32 can move along its linear path so that the detent member 32 is removed from the park gear notch 30. With the detent member 32 out of the park gear notch 30, the operator can move the shift lever assembly 14 from the park gear position to another desired gear position. When the predetermined conditions are again unmet (for example, the foot brake pedal is released or the key is out of the ignition), the control circuit is open so that electric current no longer flows through the control member 42. When the electric current stops flowing through the control member 42, it begins to cool and the effective length of the control member 42 returns to its ambient state as the spring member pushes the stopper member 40 in a rearward direction back toward its locking position.

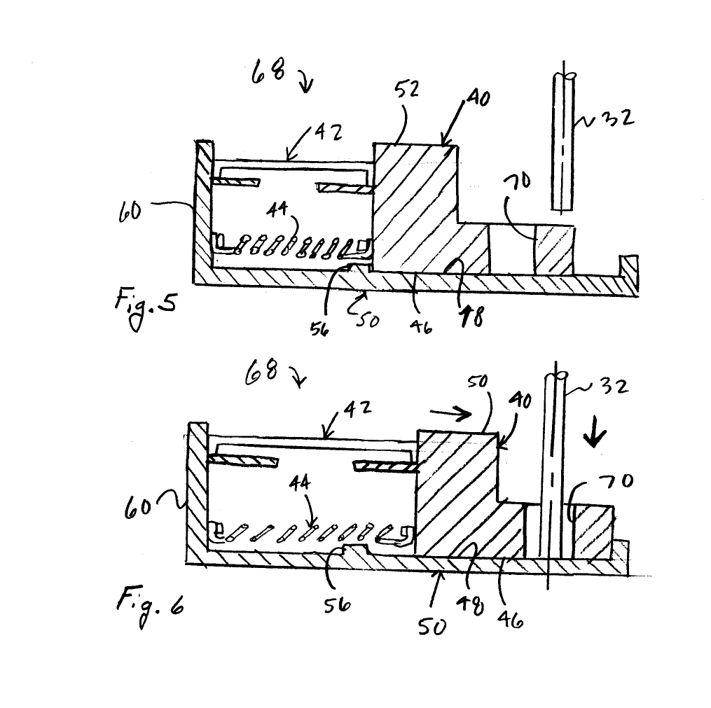

FIGS. 5 and 6 illustrate a locking mechanism 68 according to a second embodiment of the present invention wherein like reference numbers are utilized to indicate like structure. The locking mechanism 68 according to the second embodiment is substantially the same as the locking mechanism 18 according to the first embodiment except that the control member 42 is configured to increase its effective length when heated and the spring member 44 is a tension spring.

As best shown in FIG. 5, the spring member 44 biases the stopper member 40 to its locking position within the path of the detent member 32 and against the stop 56 when the shift lever assembly 14 is in the park position P. If the predetermined conditions are not met (for example, the foot brake pedal is not depressed and the key is not in or operating the ignition), the control member 42 is unactivated, that is, unheated. If the operator actuates the knob assembly 16 to move the shift lever assembly 14 while the control member 42 is unactivated, the detent member 32 engages the stopper member 40. The engagement with the stopper member 40 prevents further downward movement of the detent member 32 along its linear path so that the detent member 32 cannot be removed from the park gear notch 30. Thus, the operator cannot remove the shift lever assembly 14 from the park gear position. If the predetermined conditions are met (for example, the foot brake pedal is depressed and the key is in or operating the ignition), the switches 64 and 66 are closed so that electric current flows through the control member 42 to heat the control member 42. When the control member 42 is activated, that is heated, the effective length of the control member 42 is increased to push the stopper member 40 in a rearward direction toward its unlocking position against the bias of the spring member 44. As best shown in FIG. 3, if the operator actuates the knob assembly 16 to move the shift lever assembly 14 while the control member 42 is activated, an aperture 70 of the stopper member 40 is aligned with the path of the detent member 32 and the detent member 32 can move along its linear path so that the detent member 32 is removed from the park gear notch 30. With the detent member 32 out of the park gear notch 30, the operator can move the shift lever assembly 14 from the park gear position to another desired gear position. When the predetermined conditions are again unmet (for example, the foot brake pedal is released or the key is taken out of the ignition), the control circuit is open so that electric current no longer flows through the control member 42. When the electric current stops flowing through the control member 42, it begins to cool and the effective length of the control member 42 returns to its ambient state as the spring member pulls the stopper member 40 in a rearward direction back toward its locking position.

It is noted that each of the features of the various disclosed embodiments can be utilized with any of the other disclosed embodiments. For example, the second embodiment can alternatively utilize a compression spring like the first embodiment and the third embodiment can alternatively increase its effective length when heated like the second embodiment. From the foregoing disclosure and detailed description of certain preferred embodiments, it is apparent that the present invention provides devices that have relatively low noise by eliminating previously used electric solenoids.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A locking mechanism for a shift lever, said locking mechanism comprising, in combination:
a detent member movable along a predetermined path;
a stopper member movable between a locking position wherein the stopper member is within the path of the detent member to block movement of the detent member along at least a portion of the path and an unlocking position wherein stopper member is positioned to permit the detent member to move along the path;
a control member comprising a shape memory alloy; and
wherein the control member selectively applies a force to the stopper member to move the stopper member toward the unlocking position in response to heat being applied to the shape memory alloy.

2. The locking mechanism according to claim 1, further comprising a spring member resiliently biasing the stopper member toward the locking position.

3. The locking mechanism according to claim 2, wherein said stopper member is movable relative to a base, and the spring member and the control member each act between the base and the stopper member.

4. The locking mechanism according to claim 1, wherein said shape memory alloy is Nickel-Titanium.

5. The locking mechanism according to claim 1, wherein the control member comprises a shape memory alloy wire.

6. The locking mechanism according to claim 5, wherein the control member comprises a Nickel-Titanium wire.

7. The locking mechanism according to claim 1, wherein an effective length of the control member decreases when the shape memory alloy is heated to pull the stopper member toward the unlocking position.

8. The locking mechanism according to claim 1, wherein an effective length of the control member increases when the shape memory alloy is heated to push the stopper member toward the unlocking position.

9. The locking mechanism according to claim 1, wherein electric current flows through the shape memory alloy to heat the shape memory alloy.

10. The locking mechanism according to claim 9, wherein the shape memory alloy is electrically connected to a power source.

11. A locking mechanism for a shift lever, said locking mechanism comprising, in combination:
a detent member movable along a predetermined path;
a stopper member movable between a locking position wherein the stopper member is within the path of the detent member to block movement of the detent member along at least a portion of the path and an unlocking position wherein stopper member is positioned to permit the detent member to move along the path;
a control member comprising Nickel-Titanium;
wherein the control member selectively applies a force to the stopper member to move the stopper member toward the unlocking position in response to heat being applied to the Nickel-Titanium; and
a spring member resiliently biasing the stopper member toward the locking position.

12. The locking mechanism according to claim 11, wherein the spring member is a compression coil spring.

13. The locking mechanism according to claim 11, wherein said stopper member is movable relative to a base, and the spring member and the control member each act between the base and the stopper member.

14. The locking mechanism according to claim 11, wherein the control member comprises a Nickel-Titanium wire.

15. The locking mechanism according to claim 11, wherein an effective length of the control member decreases when the Nickel-Titanium is heated to pull the stopper member toward the unlocking position.

16. The locking mechanism according to claim 11, wherein an effective length of the control member increases when the Nickel-Titanium is heated to push the stopper member toward the unlocking position.

17. The locking mechanism according to claim 11, wherein electric current flows through the shape memory alloy to heat the shape memory alloy.

18. The locking mechanism according to claim 17, wherein the shape memory alloy is electrically connected to a power source.

19. A locking mechanism for a shift lever, said locking mechanism comprising, in combination:
a detent member movable along a predetermined path;
a stopper member movable between a locking position wherein the stopper member is within the path of the detent member to block movement of the detent member along at least a portion of the path and an unlocking position wherein stopper member is positioned to permit the detent member to move along the path;
a control member comprising a Nickel-Titanium wire;
wherein the control member selectively applies a force to the stopper member to move the stopper member toward the unlocking position in response to heat being applied to the Nickel-Titanium wire;
wherein an effective length of the control member decreases when the Nickel-Titanium wire is heated to pull the stopper member toward the unlocking position; and
a spring member resiliently biasing the stopper member toward the locking position.

20. The locking mechanism according to claim 19, wherein electric current flows through the shape memory alloy to heat the shape memory alloy
